(19) United States
(12) Patent Application Publication
(10) Pub. No.: US 2023/0318097 A1
(43) Pub. Date: Oct. 5, 2023

(54) BATTERIES AND METHODS OF MAKING THE SAME

(71) Applicant: Medtronic, Inc., Minneapolis, MN (US)

(72) Inventors: Gaurav Jain, Edina, MN (US); Prabhakar A. Tamirisa, Brooklyn Park, MN (US); Kaimin Chen, Shoreview, MN (US)

(21) Appl. No.: 18/114,027

(22) Filed: Feb. 24, 2023

Related U.S. Application Data
(60) Provisional application No. 63/325,334, filed on Mar. 30, 2022.

(51) Int. Cl. H01M 50/124; H01M 50/491; H01M 10/0565; H01M 10/0525

(52) U.S. Cl. CPC H01M 50/1243; H01M 50/491; H01M 10/0565; H01M 10/0525; H01M 2300/0082; H01M 2300/0085

(57) ABSTRACT

A battery including a conductive housing, a header assembly, and electrode assembly where the electrode assembly includes a solid-state electrolyte. A battery including a conductive housing having an inner surface and an outer surface, a header assembly, an electrode assembly, and an electrically insulative coating on at least a portion of the inner surface of the conductive housing.

### FIELD

The present disclosure relates generally to electrochemical batteries. The present disclosure further relates to non-neutral case primary and secondary batteries that include one or more features that reduce or prevent electrolyte contact with the case and/or header of the battery.

### BACKGROUND

In some cases, particularly with regard to medical devices that use primary and secondary batteries, battery cases are constructed to be at non-neutral polarity. For example, lithium primary and lithium-ion secondary batteries may have cases that are at a negative polarity. The case being at a non-neutral polarity may promote the plating of lithium metal on unwanted regions of the battery, such as regions of the case and/or header. Unwanted lithium plating may decrease the life of the battery and/or reduce the capacity of the battery. As such, further improvements to batteries that have cases at non-neutral polarities are desired.

### SUMMARY

The present disclosure describes, in one aspect, a battery. The battery includes a conductive housing having an inner surface, an outer surface, a proximal end, and a distal end. The battery also includes a header assembly disposed at the proximal end. The header assembly includes a header cap where the header cap has an inner surface. The battery further includes an electrode assembly disposed within the conductive housing proximate to the inner surface and between the proximal end and the distal end of the conductive housing. The electrode assembly includes at least two electrodes including a cathode and an anode, an interelectrode region defining and interelectrode volume, and a solid-state electrolyte.

In another aspect, the present disclosure describes a battery. The battery includes a conductive housing having an inner surface, an outer surface, a proximal end, and a distal end. At least a portion of the inner surface of the conductive housing is coated with an electrically insulative coating. The battery also includes a header assembly disposed at the proximal end. The header assembly includes a header cap where the header cap has an inner surface. The battery further includes an electrode assembly disposed within the conductive housing proximate to the inner surface and between the proximal end and the distal end of the conductive housing. The electrode assembly includes at least two electrodes including a cathode and an anode, an interelectrode region defining and interelectrode volume, and an electrolyte.

In another aspect, the present disclosure describes a battery. The battery includes a conductive housing having an inner surface, an outer surface, a proximal end, and a distal end. The battery also includes a header assembly disposed at the proximal end. The battery further includes an electrode assembly disposed within the conductive housing proximate to the inner surface and between the proximal end and the distal end of the conductive housing. The electrode assembly includes at least two electrodes including a cathode and an anode, an interelectrode region defining and interelectrode volume, and a solid-state electrolyte. The solid-state electrolyte is prepared by mixing an electrolyte pre-cursor to form a solid-state precursor mixture; adding a volume of the solid-state precursor mixture to the electrode assembly, the volume being the same or less than the void volume; and forming the solid-state electrolyte, the solid-state electrolyte being confined to the void volume.

In yet another aspect, the present disclosure describes a method, the method includes constructing a conductive housing having an inner surface, a proximal end and a distal end. The method further includes coupling a header assembly to the proximal end. The method further includes preparing an electrode assembly comprising at least two electrodes comprising an anode and a cathode, an interelectrode region, and a solid-state electrolyte. The method further includes disposing the electrode assembly within the conductive housing proximate the inner surface and between the proximal end and the distal end of the conductive housing.

In some embodiments, the cathode includes pores. The cathode pores and the interelectrode volume define a void volume and the solid-state electrolyte is confined to the void volume. In some embodiments, the interactome region includes a porous separator.

### BRIEF DESCRIPTION OF FIGURES

FIG. 1A is a schematic cross-sectional view of a battery of an illustrative embodiment.

FIG. 1B is a schematic cross-sectional view of an electrode assembly of the battery in FIG. 1A.

FIG. 2 is a flow diagram illustrating an overview of a solid-state electrolyte deposition method consistent with embodiments of the present disclosure.

### DEFINITIONS

All scientific and technical terms used herein have meanings commonly used in the art unless otherwise specified. The definitions provided herein are to facilitate understanding of certain terms used frequently herein.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

### DETAILED DESCRIPTION

In some cases, particularly with regard to medical devices that use primary or secondary batteries, such as lithium or lithium-ion batteries, the battery case is constructed to be at a non-neutral polarity (e.g., negative or positive polarity). This may result in the plating of lithium metal on the case and/or header cap, outside the electrode assembly region. According to an embodiment of the present disclosure, the battery includes one or more features that reduces or prevents lithium plating in unwanted regions of the battery. Such features may include features that reduce or prevent the movement of the electrolyte and thus reduce or prevent the electrolyte from contacting certain regions of the non-neutral battery case. Such features may further include features that isolate the non-neutral case from the electrolyte either by providing a barrier and/or by reducing the wettability of the case by the electrolyte.

Embodiments of the present disclosure may be applied to a primary battery, such as a lithium battery. Primary batteries are single use batteries that cannot be recharged. Embodiments of the present disclosure may be applied to a secondary battery, such as a lithium-ion battery. Secondary batteries are batteries that can be recharged and reused.

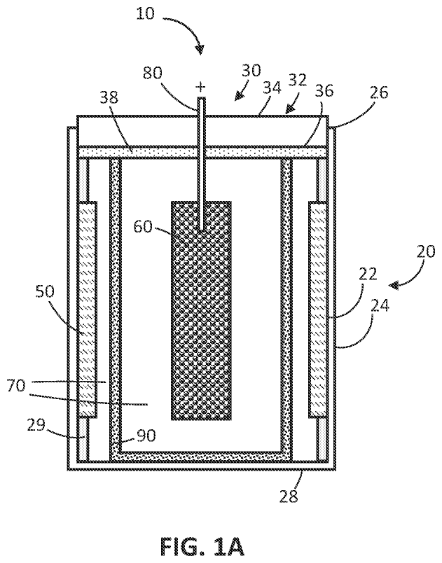

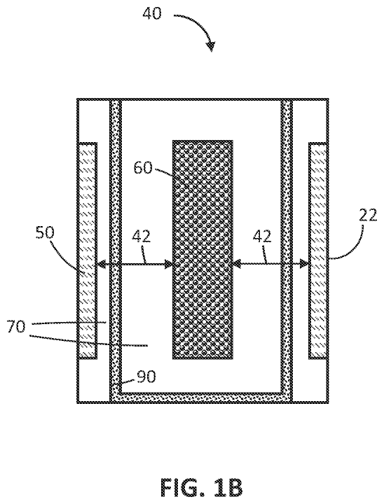

Turning to FIGS. 1A-1B, an illustrative embodiment of a battery that includes one or more of the above-described features is depicted. FIG. 1A is a cross-sectional view of a battery 10 consistent with the present disclosure. The battery 10 is generally configured to store electrical energy in the form of chemical energy. The battery 10 is also generally configured to supply electrical power to a device to which it may be operably coupled. FIG. 1A depicts the cross section of a cylindrical battery. Although not shown, one or more embodiments of the present disclosure may be applied to a prismatic battery configuration, a button/coin battery configuration, and a pouch battery configuration.

The battery 10 and the description of illustrative embodiments refer to a battery with a single cell. The term “cell” refers to a single voltaic/galvanic cell that includes an anode, a cathode, and an electrolyte. Although not explicitly shown, one or more of the embodiments of the present disclosure may be applied to a battery that include two or more cells connected in series or in parallel.

Referring now to FIG. 1A, the battery 10 includes a conductive housing 20 that has an inner surface 22, and outer surface 24, a proximal end 26, and a distal end 28. A header assembly 30 is coupled to the proximal end 26 of the conductive housing 20. An electrode assembly 40 (as shown in FIG. 1B) is disposed within the conductive housing 20 proximate to the inner surface 22 between the proximal end 26 and the distal end 28 of the conductive housing 20.

The conductive housing 20 is generally configured to contain the electrode assembly 40 of the battery 10. The conductive housing 20 is generally configured to protect the electrode assembly 40 of the battery 10. The conductive housing 20 is also generally configured to serve as a path for current to complete the circuit of the battery. To that end, a portion of the conductive housing 20 is electrically conductive, that is, the conductive housing 20 is at a non-neutral polarity. As used herein, the term “polarity” refers to electrical polarity and should be understood to represent electrical potential. In some embodiments, the conductive housing 20 is at a negative polarity. In some embodiments, the conductive housing 20 is at a positive polarity.

The conductive housing 20 may be made of any material or combination of materials that as a whole are able to conduct electricity. In some embodiments, the material includes conductive materials and non-conductive materials. In some embodiments, the material includes only conductive materials. In some embodiments, the conductive housing 20 may be made of a material that includes a metal, a polymer, or a combination thereof. Examples of metals that may be included in the conductive housing 20 material include, but are not limited to, titanium, silver, copper, gold, aluminum, zinc, nickel, iron, platinum, lead, antimony, palladium, platinum, silicon, various oxidation states thereof, and combinations thereof. The conductive housing 20 may be made of material that includes a metal alloy. Suitable example metal alloys include, but are not limited to, steel (e.g., iron-carbon alloy) and alloy steel such as, steel-chrome, steel-nickel, steel-magnesium, stainless-steel (e.g., 300 series and/or 400 series), tungsten-steel, chromium-molybdenum-steel, nickel-chromium-molybdenum-steel, chromium-vanadium-steel, and combinations thereof; various bronze alloys (e.g., copper-tin alloys) such as aluminum-bronze, copper-bronze, copper-aluminum-bronze, phosphor-bronze, and combinations thereof; various brass (e.g., copper-zinc alloys) alloys such as tin-brass (e.g., Admiralty brass), yellow brass, red brass, and combinations thereof; aluminum alloys such as aluminum-copper, aluminum-copper-magnesium, aluminum-silicon, aluminum-bronze, and combinations thereof; beryllium alloys such as beryllium-copper; copper alloys such as copper-aluminum, copper-zinc, copper-nickel (e.g., Constantan), and combinations thereof; nickel alloys such as nickel-chromium (e.g., INCONEL), nickel-niobium (e.g., Columbium), nickel-molybdenum (e.g., HASTELLOY B), nickel-chromium-molybdenum-tungsten (e.g., HASTELLOY C), titanium alloys such as titanium grades 1, 2, 5, 9, and 23; and combinations thereof; and any further alloys or combinations thereof.

The conductive housing 20 material may include one or more conductive polymers. Conductive polymers may be organic, inorganic, or a mixture thereof. Polymers may either be inherently conductive or display conductive properties upon doping. Doping refers to exposing a polymer, either during synthesis or after synthesis, to one or more reagents that impart conductive properties to the polymer. For example, doping may include exposing a polymer to oxidizing reagents, reducing agents, and/or electron-accepting reagents. Examples of organic conductive polymers include, but are not limited to, transpolyacetylene (inherent or doped), polyphenylene vinylene (inherent or doped), polypyrrole (inherent or doped), polythiophene (inherent or doped), poly(3,4-ethylenedioxydthiophene) (inherent or doped), polyaniline (inherent or doped), polycarbazoles (inherent or doped), polyindole (inherent or doped), polyazepine (inherent or doped), polyfluorene (inherent or doped), polypyrene (inherent or doped), polyazulene (inherent or doped), polynaphthalene (inherent or doped), poly(1,6-heptadiyne) (doped), polyethylene succinate (doped), polyethylene oxide (doped), polypropylene oxide (doped), polyvinyl acetate (doped), and polyphenylene sulfide (inherent or doped). An example of an inorganic conductive polymer is polythiazyl (inherent or doped).

In some embodiments, a portion of inner surface 22 of the conductive housing 20 is coated with a conductive housing insulative coating 29. The conductive housing insulative coating 29 may be any coating that is electrically non-conductive, that is, has a high resistivity. In some embodiments, the conductive insulative coating 29 is non-porous and unable to react with lithium ion (e.g., unable to intercalate lithium ions). The conductive housing insulative coating 29 may be a polymer or an inorganic compound. In some embodiments, the conductive housing insulative coating 29 may function to decrease the likelihood of unwanted lithium plating on the inner surface 22 of the conductive housing 20. As such, in some embodiments, the conductive housing insulative coating 29 may function to decrease the likelihood of internal short circuiting of the battery 10.

In some embodiments, the conductive housing insulative coating 29 is a polymer. In some embodiments the conductive housing insulative coating 29 includes one or more of a fluoropolymer such as tetrafluoroethylene, polytetrafluoroethylene, polyvinylidene fluoride, or a combination thereof; a chloropolymer such as polyvinylchloride; another type of polymer such as parylene, poly(ethylene:vinyl acetate), polyether urethane-urea, polyetheretherketone (PEEK), aromatic polyamide, polycarbonate, polyester, polyolefin, polystyrene, polysulfone, polyurethane, polyphenylene sulfide, or a combination thereof. In some embodiments, the polymer is or includes a thermoset resin. A thermoset resin is a polymer that is irreversibly cured by exposure to heat. Examples of suitable thermoset resins include, but are not limited to, epoxy resins, polyimide resins, bismaleimide resins, phenol-based resins (e.g., novalac resins), and combinations thereof.

In some embodiments, the conductive housing insulative coating 29 includes one or more inorganic compounds. Examples of suitable inorganic compounds include alumina, tantalum nitride, diamond-like carbon, zirconia, and combinations thereof.

In some embodiments, 5% or greater, 10% or greater, 20% or greater, 30% or greater, 40% or greater, 50% or greater, 60% or greater, 70% or greater, 80% or greater, 90% or greater, 95% or greater, or 99% or greater of the surface area of the inner surface 22 of the conductive housing 20 is coated with a conductive housing insulative coating 29. In some embodiments, 99.9% or less, 99% or less, 95% or less, 90% or less, 80% or less, 70% or less, 60% or less, 50% or less, 40% or less, 30% or less, 20% or less, or 10% or less of the surface area of the inner surface 22 of the conductive housing 20 is coated with a conductive housing insulative coating 29. In some embodiments, 5% to 99.9%, 5% to 99%, 5% to 95%, 5% to 90%, 5% to 80%, 5% to 70%, 5% to 60%, 5% to 50%, 5% to 40%, 5% to 30%, 5% to 20%, or 5% to 10% of the surface area of the inner surface 22 of the conductive housing 20 is coated with a conductive housing insulative coating 29. In some embodiments, 10% to 99.9%, 10% to 99%, 10% to 95%, 10% to 90%, 10% to 80%, 10% to 70%, 10% to 60%, 10% to 50%, 10% to 40%, 10% to 30%, or 10% to 20% of the surface area of the inner surface 22 of the conductive housing 20 is coated with a conductive housing insulative coating 29. In some embodiments, 20% to 99.9%, 20% to 99%, 20% to 95%, 20% to 90%, 20% to 80%, 20% to 70%, 20% to 60%, 20% to 50%, 20% to 40%, or 20% to 30% of the surface area of the inner surface 22 of the conductive housing 20 is coated with a conductive housing insulative coating 29. In some embodiments, 30% to 99.9%, 30% to 99%, 30% to 95%, 30% to 90%, 30% to 80%, 30% to 70%, 30% to 60%, 30% to 50%, or 30% to 40% of the surface area of the inner surface 22 of the conductive housing 20 is coated with a conductive housing insulative coating 29. In some embodiments, 40% to 99.9%, 40% to 99%, 40% to 95%, 40% to 90%, 40% to 80%, 40% to 70%, 40% to 60%, or 40% to 50% of the surface area of the inner surface 22 of the conductive housing 20 is coated with a conductive housing insulative coating 29. In some embodiments, 50% to 99.9%, 50% to 99%, 50% to 95%, 50% to 90%, 50% to 80%, 50% to 70%, or 50% to 60% of the surface area of the inner surface 22 of the conductive housing 20 is coated with a conductive housing insulative coating 29. In some embodiments, 60% to 99.9%, 60% to 99%, 60% to 95%, 60% to 90%, 60% to 80%, or 60% to 70% of the surface area of the inner surface 22 of the conductive housing 20 is coated with a conductive housing insulative coating 29. In some embodiments, 70% to 99.9%, 70% to 99%, 70% to 95%, 70% to 90%, or 70% to 80% of the surface area of the inner surface 22 of the conductive housing 20 is coated with a conductive housing insulative coating 29. In some embodiments, 80% to 99.9%, 80% to 99%, 80% to 95%, or 80% to 90% of the surface area of the inner surface 22 of the conductive housing 20 is coated with a conductive housing insulative coating 29. In some embodiments, 90% to 99.9%, 90% to 99%, or 90% to 95% of the surface area of the inner surface 22 of the conductive housing 20 is coated with a conductive housing insulative coating 29. In some embodiments, 95% to 99.9% or 95% to 99% of the surface area of the inner surface 22 of the conductive housing 20 is coated with a conductive housing insulative coating 29. In some embodiments, 99% to 99.9% of the surface area of the inner surface 22 of the conductive housing 20 is coated with a conductive housing insulative coating 29.

A header assembly 30 is coupled to the proximal end 26 of the conductive housing 20. The header assembly 30 is generally configured to operably couple at least one terminal of the battery 10 to a device that the battery is configured to supply energy to. The header assembly 30 of the illustrative embodiment in FIG. 1A includes a positive terminal (indicated by the +). In some embodiments, a feedthrough pin 80 is exposed to the external environment around the battery 10 through the positive terminal. The feedthrough pin 80 is generally configured to operably couple the positive terminal of battery 10 to the device. Although not shown, in some embodiments, the header assembly 30 may include a positive terminal and a negative terminal. In some embodiments, the header assembly 30 may include additional components, for example, a plastic and/or glass seal.

The header assembly 30 includes a header cap 32. The header cap 32 has a header cap inner surface 36 and a header cap outer surface 34. The outer surface 34 is exposed to the environment outside the battery 10. The inner surface 36 is proximate the electrode assembly 40 and the inner surface 22 of the conductive housing 20. The header cap 32 is generally configured to protect the electrode assembly 40 that is disposed within the conductive housing 20. The header cap 32 may be made of any suitable material such as metal, ceramic, polymer, or combinations thereof. Example metal materials include those described relative to the conductive housing 20. Example polymeric materials include those described elsewhere herein such as relative to the conductive housing 20 and those relative to the conductive housing insulative coating 29.

In some embodiments, a portion of the header cap 32 is integral with the conductive housing 20. In some embodiments, the header cap 32 is not integral with the conductive housing 20. In embodiments, where the header cap 32 is not integral with the conductive housing 20, any suitable method may be used to couple the header cap 32 to the conductive housing 20 such as welding and soldering.

In some embodiments or greater, a portion of the header cap inner surface 36 is coated with a header cap insulative coating 38. The header cap insulative coating 38 may be any coating that is non-conductive, that is, has a high resistivity. The header cap insulative coating 38 may be a polymer or an inorganic compound such as those described relative to the conductive housing insulative coating 29. In embodiments where the battery includes a header cap insulative coating 38 and a conductive housing insulative coating 29, the coatings may be made of the same material. In embodiments where the battery includes a header cap insulative coating 38 and a conductive housing insulative coating 29, the coatings may be made of different materials. In some embodiments, the header cap insulative coating 38 may function to decrease the likelihood of unwanted lithium plating on the inner surface of the header cap 32. As such, in some embodiments, the header cap insulative coating 38 may function to decrease the likelihood of internal short circuiting of the battery 10.

In some embodiments, a portion of the surface area of the header cap inner surface 36 is coated with the header cap insulative coating 38. In some embodiments 95% or greater, 90% or greater, 80% or greater, 70% or greater, 60% or greater, or 50% or greater of the surface area of the header cap inner surface 36 is coated with the header cap insulative coating 38. In some embodiments no more than 99.9% or less, 90% or less, 80% or less, 70% or less, or 60% or less of the surface area of the header cap inner surface 36 is coated with the header cap insulative coating 38. In some embodiments, 50% to 99.9%, 50% to 95%, 50% to 90%, 50% to 80%, 50% to 70%, or 50% to 60% of the surface area of the header cap inner surface 36 is coated with the header cap insulative coating 38. In some embodiments, 60% to 99.9%, 60% to 95%, 60% to 90%, 60% to 80%, or 60% to 70% of the surface area of the header cap inner surface 36 is coated with the header cap insulative coating 38. In some embodiments, 70% to 99.9%, 70% to 95%, 70% to 90%, or 70% to 80% of the surface area of the header cap inner surface 36 is coated with the header cap insulative coating 38. In some embodiments, 80% to 99.9%, 80% to 95%, or 800 to 90% of the surface area of the header cap inner surface 36 is coated with the header cap insulative coating 38. In some embodiments, 90% to 99.9% or 90% to 95% of the surface area of header cap inner surface 36 is coated with the header cap insulative coating 38. In some embodiments, 95% to 99.9% of the surface area of the header cap inner surface 36 is coated with the header cap insulative coating 38.

Turning to FIG. 1B, the battery 10 includes an electrode assembly 40. The electrode assembly 40 includes at least two electrodes (e.g., an anode 50 and a cathode 60), an interelectrode region 42, and an electrolyte 70. In some embodiments, the electrolyte 70 may be a solid-state electrolyte (discussed elsewhere herein). In some embodiments, the electrolyte 70 may be a liquid electrolyte (discussed elsewhere herein).

The at least two electrodes include an anode 50 and a cathode 60. The anode 50 is generally configured as a negative electrode at which oxidation reactions take place. In lithium and lithium-ion batteries, the anode 50 generally includes lithium. The lithium may be in the form of metallic lithium, or lithium intercalating materials such as graphite, lithium titanate (Li₄Ti₅O₁₂), or lithium alloys such as lithium-aluminum, lithium-silicon, lithium-bismuth, lithium-cadmium, lithium-magnesium, lithium-tin, lithium-antimony, lithium-germanium, lithium-lead, oxides thereof, sulfides thereof, phosphides thereof, carbides thereof, nitrides thereof, and combinations thereof. In some embodiments, the anode 50 includes metallic lithium.

The cathode 60 is generally configured as a positive electrode at which reduction reactions take place. Examples of cathode materials include, but are not limited to, lithium cobalt oxide (e.g., LiCoO₂), lithium iron phosphate (e.g., LiFePO₄), lithium magnesium oxide (e.g., LiMn₂O₄), lithium nickel manganese cobalt oxide (e.g., Li(NiMnCo)O₂), lithium nickel oxide (e.g., LiNiO₂), lithium nickel cobalt aluminum oxide (e.g., Li(NiCoAl)O₂), carbon monofluoride, silver vanadium oxide (e.g., Ag₂V₄O₁₁), manganese dioxide (MnO₂), and combinations thereof. In some embodiments where the battery is primary battery, the cathode may include carbon monofluoride, silver vanadium oxide (e.g., Ag₂V₄O₁₁), or both. In some embodiments where the battery is a primary battery, the cathode may include manganese dioxide (MnO₂). The cathode may further include additional components, for example, one or more polymers.

In one or more embodiments, the cathode 60 is porous. The degree of the porous structure of the cathode 60 may be quantified as porosity. Porosity is unitless and often given as a percent. Porosity may be calculated using equation 1;

$$porosity = \frac{{V}_{P}}{{V}_{T}} \times 100$$

where V_{P} is the total pore volume and V_{T} is the total volume. For the cathode 60, V_{P} is total pore volume of the cathode 60. For the cathode 60, V_{T} is sum of the total pore volume and the total solid volume of the cathode. The V_{P}, V_{T}, and thus the porosity of the cathode 60 may be quantified using a variety of methods such as mercury porosimetry; the nitrogen adsorption isotherm method or x-ray, neutron, or other optical imaging methods.

In some embodiments, the cathode 60 has a porosity that is 5% or greater, 10% or greater, 15% or greater, 20% or greater, 30% or greater, or 40% or greater. In some embodiments, the cathode 60 has a porosity that is 50% or less, 40% or less, 30% or less, 20% or less, 15% or less, or 10% or less. In some embodiments, the cathode 60 has a porosity that is 5% to 50%, 5% to 40%, 5% to 30%, 5% to 20%, 5% to 15%, or 5% to 10%. In some embodiments, the cathode 60 has a porosity that is 10% to 50%, 10% to 40%, 10% to 30%, 10% to 20%, or 10% to 15%. In some embodiments, the cathode 60 has a porosity that is 15% to 50%, 15% to 40%, 15% to 30%%, or 15% to 20%. In some embodiments, the cathode 60 has a porosity that is 20% to 50%, 20% to 40%, or 20% to 30%. In some embodiments, the cathode 60 has a porosity that is 30% to 50% or 30% to 40%. In some embodiments, the cathode 60 has a porosity that is 40% to 50%. In some embodiments, the cathode 60 has a porosity that is 15% to 40%. In some embodiments, the cathode 60 has a porosity that is 15% to 30%.

In some embodiments or greater, one electrode is physically, and as such, electrically coupled with (e.g., coated on) the conductive case. Physical coupling of at least one electrode to the conductive housing 20 gives the conductive housing 20 a non-neutral polarity. For example, in embodiments when the anode 50 is physically coupled to at least a portion of the conductive housing 20, the conductive housing 20 is at a negative polarity. In embodiments, when the cathode 60 is physically coupled to at least a portion of the conductive housing 20, the conductive housing 20 is at a positive polarity.

In some embodiments, a portion of the inner surface 22 of the conductive housing 20 is coated with an electrode (e.g., the anode or the cathode). In some embodiments, as illustrated in FIG. 1A, a portion of the inner surface of the conductive housing 20 is coated with the anode. Although not shown, it is contemplated that in some embodiments at least a portion of the inner surface of the conductive housing 20 is coated with the cathode.

In some embodiments 0.1% or greater, 1% or greater, 5% or greater, 10% or greater, 20% or greater, 30% or greater, 40% or greater, 50% or greater, 60% or greater, 70% or greater, 80%, or 90% or greater of the surface area of the inner surface 22 of the conductive housing 20 is coated with an electrode. In some embodiments 95% or less, 90% or less, 80% or less, 70% or less, 60% or less, 50% or less, 40%, or less, 30% or less, 20% or less, 10% or less, 5% or less, or 1% or less of the surface area of the inner surface 22 of the conductive housing 20 is coated with an electrode. In some embodiments, 0.1% to 95%, 0.1% to 90%, 0.1% to 80%, 0.1% to 70%, 0.1% to 60%, 0.1% to 50%, 0.1% to 40%, 0.1% to 30%, 0.1% to 20%, 0.1% to 10%, 0.1% to 5%, or 0.1% to 1% of the surface area of the inner surface 22 of the conductive housing 20 is coated with an electrode. In some embodiments, 1% to 95%, 1% to 90%, 1% to 80%, 1% to 70%, 1% to 60%, 1% to 50%, 1% to 40%, 1% to 30%, 1% to 20%, 1% to 10%, or 1% to 5% of the surface area of the inner surface 22 of the conductive housing 20 is coated with an electrode. In some embodiments, 5% to 95%, 5% to 90%, 5% to 80%, 5% to 70%, 5% to 60%, 5% to 50%, 5% to 40%, 5% to 30%, 5% to 20%, or 5% to 10% of the surface area of the inner surface 22 of the conductive housing 20 is coated with an electrode. In some embodiments, 10% to 95%, 10% to 90%, 10% to 80%, 10% to 70%, 10% to 60%, 10% to 50%, 10% to 40%, 10% to 30%, or 10% to 20% of the surface area of the inner surface 22 of the conductive housing 20 is coated with an electrode. In some embodiments, 20% to 95%, 20% to 90%, 20% to 80%, 20% to 70%, 20% to 60%, 20% to 50%, 20% to 40%, or 20% to 30% of the surface area of the inner surface 22 of the conductive housing 20 is coated with an electrode. In some embodiments, 30% to 95%, 30% to 90%, 30% to 80%, 30% to 70%, 30% to 60%, 30% to 50%, or 30% to 40% of the surface area of the inner surface 22 of the conductive housing 20 is coated with an electrode. In some embodiments, 40% to 95%, 40% to 90%, 40% to 80%, 40% to 70%, 40% to 60%, or 40% of the surface area of the inner surface 22 of the conductive housing 20 is coated with an electrode. In some embodiments, 50% to 95%, 50% to 90%, 50% to 80%, 50% to 70%, or 50% to 60% of the surface area of the inner surface 22 of the conductive housing 20 is coated with an electrode. In some embodiments, 60% to 95%, 60% to 90%, 60% to 80%, or 60% to 80% of the surface area of the inner surface 22 of the conductive housing 20 is coated with an electrode. In some embodiments, 70% to 95%, 70% to 90%, or 70% to 80% of the surface area of the inner surface 22 of the conductive housing 20 is coated with an electrode. In some embodiments, 80% to 95%, or 80% of the surface area of the inner surface 22 of the conductive housing 20 is coated with an electrode. In some embodiments, 90% to 95% of the surface area of the inner surface 22 of the conductive housing 20 is coated with an electrode.

In some embodiments, a portion of the inner surface 22 of the conductive housing 20 may be coated with an electrode and at least a portion of the inner surface 22 of the conductive housing 20 not coated with the electrode is coated with a conductive housing insulative coating 29. In some embodiments a greater proportion of the surface area of the inner surface 22 of the conductive housing is coated with an electrode than the conductive housing insulative coating 29. In some embodiments a greater proportion of the surface area of the inner surface 22 of the conductive housing is coated with conductive housing insulative coating 29 than the electrode.

In some embodiments, the surface area of the electrode relative to the surface area of the conductive housing insulative coating 29 on the inner surface 22 of the conductive housing is one part or greater, five parts or greater, or nine parts or greater for every one part of the conductive housing insulative coating 29. In some embodiments, the surface area of the electrode relative to the surface area of the conductive housing insulative coating 29 on the inner surface 22 of the conductive housing is ten parts or less, nine parts or less, or five parts or less for every one part of the conductive housing insulative coating 29. In some embodiments, the surface area of the electrode relative to the surface area of the conductive housing insulative coating 29 on the inner surface 22 of the conductive housing is one part to ten parts, one part to nine parts, or one part to five parts for every one part of the conductive housing insulative coating 29. In some embodiments, the surface area of the electrode relative to the surface area of the conductive housing insulative coating 29 on the inner surface 22 of the conductive housing is five parts to ten parts or five parts to nine parts for every one part of the conductive housing insulative coating 29. In some embodiments, the surface area of the electrode relative to the surface area of the conductive housing insulative coating 29 on the inner surface 22 of the conductive housing is nine parts to ten parts for every one part of the conductive housing insulative coating 29. In some embodiments, the surface area of the electrode relative to the surface area of the conductive housing insulative coating 29 on the inner surface 22 of the conductive housing is nine parts to every one part of the conductive housing insulative coating 29. Although not depicted, in some embodiments, at least a portion of the inner surface 22 of the conductive housing may be coated with a conductive insulative coating 29 and at least a portion of the conductive housing insulative coating 29 is coated with the electrode, that is, the conductive housing insulative coating 29 and the electrode overlap. The electrode coating the conductive housing insulative coating 29 must maintain electrical contact with the conductive housing 20. Electrical contact may be maintained, for example, through a spot weld. In some embodiments, the spot weld may penetrate through the conductive housing insulative coating 29 to establish a physical and electrical connection between the conductive housing 20 and the electrode that is coated on the conductive housing insulative coating 29. For example, in some embodiments, 99.9% of the surface area of the inner surface 22 of the conductive housing 20 is coated with a conductive housing insulative coating 29 and 0.1% of the surface area of the inner surface 22 of the conductive housing 20 is coated with the electrode. In some embodiments, 99% of the surface area of the inner surface 22 of the conductive housing 20 is coated with a conductive housing insulative coating 29 and 1% of the surface area of the inner surface 22 of the conductive housing 20 is coated with the electrode. In some embodiments, 95% of the surface area of the inner surface 22 of the conductive housing 20 is coated with a conductive housing insulative coating 29 and 5% of the surface area of the inner surface 22 of the conductive housing 20 is coated with the electrode.

The electrode assembly 40 includes an electrolyte 70. In some embodiments, the electrolyte is a solid-state electrolyte. A solid-state electrolyte is an electrolyte that does not include free flowing liquid. Solid-state electrolytes include all-solid-state electrolytes and quasi-solid-state electrolytes. In some embodiments, the solid-state electrolyte includes an all-solid-state electrolyte. All-solid-state electrolytes have no liquid. Examples of all-solid-state electrolytes include inorganic solid electrolytes and solid polymer electrolytes. In some embodiments, the solid-state electrolyte includes a quasi-solid-state electrolyte. Quasi-solid-state electrolytes include an amount of liquid that is immobilized inside a solid matrix. Quasi-solid-state electrolytes include gel polymer electrolytes, plastic crystal electrolytes, ionogel electrolytes, and gel electrolytes. In some embodiments, the solid-state electrolyte includes a gel polymer electrolyte, a plastic crystal electrolyte, an inorganic electrolyte, or a combination thereof.

In some embodiments, the solid-state electrolyte is a gel polymer electrolyte. A gel polymer electrolyte includes a polymer network that immobilizes a liquid electrolyte containing a solvent and lithium salt. The polymer network may include one or more polymers. Examples of lithium salts that may be included in a gel polymer electrolyte include, but are not limited to, lithium triflate, lithium bis(oxalato) borate, lithium hexafluorophosphate, lithium hexafluoroarsenate, lithium trifluoromethanesulfonate, lithium oxalyldifluoroborate, lithium tetrafluoroborate, lithium bisfluorosulfonimide, lithium bistrifluoromethylsulfonimide, lithium difluorophosphate, lithium 4,5-dicyano-2-trifluoromethylimidazolium, lithium difluoro(oxalato)borate, lithium perchlorate, lithium tris(trifluoromethanesulphonyl) methide, and combinations thereof. Example polymers that may be included in a gel polymer electrolyte include, but are not limited to, poly(ethylene oxide) and copolymers such as poly(ethylene-propylene oxide); polymers based on the acrylic group such as poly(methyl methacrylate), poly(acrylic acid), lithium poly(acrylate), poly(ethylene glycol diacrylate), and combinations thereof; polymers based on the vinylidene fluoride group such as poly(vinylidene fluoride) (PVdF), copolymers such as poly (vinylidene fluoride-hexafluoropropylene) (PVdF-HFP), and combinations thereof; and combinations thereof. Example solvents that may be included in a gel polymer electrolyte include, but are not limited to, ethylene carbonate, propylene carbonate, diethyl carbonate, dimethyl carbonate, poly(ethylene glycol), dimethyl sulfoxide, glymes such as monoglyme, diglyme, triglyme and tetraglyme, other aprotic solvents, and combinations thereof. Any suitable combination of one or more lithium salts, one or more polymers, and one or more solvents may be used in a gel polymer electrolyte.

In some embodiments, the gel polymer electrolyte includes LiAsF₆, propylene carbonate/1,2-dimethoxy ethane, and polyethylene oxide (PEO). In some embodiments, the gel polymer electrolyte includes 1 M LiAsF₆ in 50:50 (vol. %) propylene carbonate/1,2-dimethoxy ethane gelled with polyethylene oxide (PEO); the weight % of PEO in the gel polymer electrolyte being between 5-20%.

In some embodiments, the gel polymer electrolyte includes LiBF₄ (lithium tetrafluoroborate), gamma-butyrolactone/1,2-dimethoxyethane, and polyethylene oxide (PEO). In some embodiments, the gel polymer electrolyte includes 1 M LiBF₄ (lithium tetrafluoroborate) in 60:40 (vol. %) gamma-butyrolactone/1,2-dimethoxyethane gelled with polyethylene oxide (PEO); the weight % of PEO in the gel polymer electrolyte being between 5-20%.

In some embodiments, the gel polymer electrolyte includes LiTFSI (lithium bis(trifluoromethanesulfonyl)imide), tetraglyme, and polyethylene oxide (PEO). In some embodiments, the gel polymer electrolyte includes 50 mole-% LiTFSI in tetraglyme gelled with polyethylene oxide; the weight % PEO in the gelled electrolyte being between 5-50% In some embodiments, the gel polymer electrolyte is a gel polymer electrolyte as described in U.S. Pat. No. 9,911,984 to Tamirisa et al.; U.S. Pat. No. 10,333,173 to Ye et al.; U.S. Pat. No. 10,587,005 to Li et al.; or U.S. Pat. No. 10,727,499 to Tamirisa et al., each of which are incorporated here by reference. In some embodiments, the solid-state electrolyte is a plastic crystal electrolyte. A plastic crystal is crystal where the molecules making up the crystal weakly interact to impose degree of long-range translational order while maintaining a degree of orientational or confirmational freedom. A plastic crystal electrolyte generally includes one or more lithium salts and a plastic crystal forming material capable of dissolving the one or more lithium salts. Lithium salts suitable for use in a plastic crystal electrolyte include, but are not limited to, trifluoromethanesulphonylimide, lithium bis-perfluoroethylsulphonylimide, lithium tetrafluoroborate, lithium hexafluorophosphate, lithium thiocyanate, lithium triflate, lithium tetrafluoroaluminate, lithium perchlorate, and combinations thereof.

The plastic crystal electrolyte may be a nonionic plastic crystal electrolyte, an ionic plastic crystal electrolyte, or a combination thereof. Nonionic plastic crystal electrolytes are made from neutral plastic crystal forming materials. Examples of nonionic plastic crystal forming materials include succinonitrile. Ionic plastic crystals are made from a charged plastic crystal forming material. Examples of ionic plastic crystal forming materials include, but are not limited to, phosphonium materials such as triethylmethylammonium bis(fluorosulfonyl)imide and triisobutylmethylphosphonium bis(fluorosulfonyl)imide.

In some embodiments, the solid-state electrolyte is an inorganic electrolyte. Inorganic electrolytes include one or more inorganic materials that are in a crystalline state. In lithium and lithium-ion batteries, the inorganic electrolytes generally include lithium. Examples of inorganic electrolytes include, but are not limited to, argyrodite type electrolytes such as Li₆PS₅X where X is Cl, Br, or I; perovskite type electrolytes such as Li_{0.35},La_{0.55}TiO₃; anti-perovskite type electrolyte such as Li₃OCl_{0.5}Br_{0.5}; sodium superionic conductor (NASICON) electrolyte types such as lithium aluminum titanium phosphate (LATP; e.g., Li_{1.2}Al_{0.2}Ti_{1.8}(PO₄)₃), lithium aluminum germanium phosphate lithium titanium phosphorous, and combinations thereof; lithium super ionic conductor (LISICON) type electrolyte such as lithium germanium phosphorous sulfide, lithium silico phosphorous sulfur, lithium phosphorous sulfur, Li₂₋₂ₓZn₁₋ₓGeO₄, and combinations thereof; thi-LISICON type electrolyte such as Li₁₀GeP₂S₁₂; Garnet type electrolytes such as lithium lanthanum zirconium oxide (e.g., Li₇La₃Zr₂O₁₂); sulfide glass (e.g., 0.7Li₂S-0.3P₂S₅); lithium nitrides (e.g., Li₃N); lithium hydrides (e.g., LiBH₄); lithium halides such as lithium yttrium chloride, lithium yttrium chloride, and combinations thereof; and combinations thereof.

In some embodiments, the electrolyte 70 is a liquid electrolyte. As used herein, the term “liquid electrolyte” refers to an electrolyte that is free flowing. The liquid electrolytes of the present disclosure generally include a solvent and ions dissolved within the solvent. Any salt or combinations of salts discussed relative to the gel polymer electrolyte may be included in a liquid electrolyte. Any solvent or combinations of solvents discussed relative to the gel polymer electrolyte may be included in the liquid electrolyte.

An interelectrode region 42 exists between the anode 50 and the cathode 60. The interelectrode region 42 includes an interelectrode volume (V_{I}). The interelectrode volume is the total volume in the electrode assembly 40 that is physically available to be occupied, but not necessarily occupied, by the electrolyte. In some embodiments, the interelectrode volume is the total volume in the electrode assembly 40 that is physically available to be occupied, but not necessarily occupied, by a solid-state electrolyte. For example, in some embodiments when the interelectrode region 42 includes one or more porous separators (see the discussion below), the interelectrode volume includes the pores of the separator and excludes the nonporous volume of the separator.

In some embodiments, the interelectrode region 42 includes a porous separator 90. The porous separator 90 is generally configured to inhibit direct interaction between the cathode 60 and the anode 50, thus limiting the likelihood of internal short circuits. The porous separator 90 is also generally configured to allow the transport of ions between the cathode 60 and anode 50. In some embodiments, as shown in FIGS. 1A-1B, the porous separator 90 is not in direct physical contact with an electrode. Although not shown, in some embodiments, the porous separator 90 may be in direct contact with one or more of the electrodes.

To allow for the transport of ions between the anode 50 and the cathode 60, the porous separator 90 is generally porous. At least some of the pores of the porous separator 90 are permeable, that is, they allow the ions to flow from one side of the porous separator 90 to the other side of the porous separator 90. In some embodiments, all or substantially all of the pores of the porous separator 90 are permeable. In some embodiments, a portion of the pores of the porous separator 90 are permeable and a portion of the pores are not permeable. Similar to the cathode 60, the extent of pores in the porous separator 90 may be given by the porosity described by equation 1 above. For the porous separator 90, V_{V} is the total volume of the pores in the separator and V_{T} is the sum of total volume of the pores and the total volume of the solid of the porous separator 90. The V_{V}, V_{T}, and thus the porosity of a separator may be calculated using a variety of methods such as those described relative to the cathode 60.

In some embodiments, the porosity of the porous separator 90 is 20% or greater, 30% or greater, 40% or greater, 50% or greater, 60% or greater, or 70% or greater. In some embodiments, the porosity of the porous separator 90 is 80% or less, 70% or less, 60% or less, 50% or less, 40% or less, 30% or less, or 20% or less. In some embodiments, the porosity of the porous separator 90 is 20% to 80%, 20% to 70%, 20% to 60%, 20% to 50%, 20% to 40%, or 20% to 30%. In some embodiments, the porosity of the porous separator 90 is 30% to 80%, 30% to 70%, 30% to 60%, 30% to 50%, or 30% to 40%. In some embodiments, the porosity of the porous separator 90 is 40% to 80%, 40% to 70%, 40% to 60%, or 40% to 50%. In some embodiments, the porosity of the porous separator 90 is 50% to 80%, 50% to 70%, or 50% to 60%. In some embodiments, the porosity of the porous separator 90 is 60% to 80% or 60% to 70%. In some embodiments, the porosity of the porous separator 90 is 70% to 80%. In some embodiments, the porosity of the separator is 40%-60%.

Any suitable separator may be used. Example separators include, but are not limited to, polymeric porous membranes such as polyethylene, polypropylene, polyterephthalate, polyimide, cellulose based polymers and combinations thereof; modified polymeric membranes with thin oxide coatings of titania (TiO₂), zinc oxide (ZnO), silica (SiO₂), and combinations thereof; and hybrid organic-organic assemblies such as those that contain SiO₂ nanoparticles covalently tethered within a polymeric network such as polyurethanes, polyacrylates, polyethylene glycol, and combinations thereof; and combinations thereof. In some embodiments, more than one separator may be used.

In some embodiments, the electrolyte 70 is confined to a void volume (Vᵥ). In some embodiments, a solid state electrolyte is confined to a void volume (Vᵥ). The V_{V} is defined by equation 2:

V_{V}=V_{P}+V_{I}

where V_{P} is the total cathode pore volume and V_{I} is the interelectrode volume. In embodiments that include a porous separator 90, the V_{I} is includes the total pore volume of the separator.

The electrolyte 70 may occupy a portion of the void volume (V_{V}). In some embodiments, the solid-state electrolyte may occupy a portion of the void volume (V_{V}). In some embodiments the solid-state electrolyte occupies 50% or greater, 60% or greater, 70% or greater, 80% or greater, 90% or greater, 95%, or greater than 97% of the V_{V}. In some embodiments, the solid-state electrolyte occupies 99.9% or less, 97% or less, 95% or less, 90% or less, 80% or less, 70% or less, or 60% or less of the V_{V}. In some embodiments, the solid-state electrolyte occupies 50% to 99.9%, 50% to 97%, 50% to 95%, 50% to 90%, 50% to 80% 50% to 70% or 50% to 60% of the V_{V}. In some embodiments, the solid-state electrolyte occupies 60% to 99.9%, 60% to 97%, 60% to 95%, 60% to 90%, 60% to 80%, or 60% to 70% of the V_{V}. In some embodiments, the solid-state electrolyte occupies 70% to 99.90, 70% to 97%, 70% to 95%, 70% to 900, or 70% to 80% of the V_{V}. In some embodiments, the solid-state electrolyte occupies 80% to 99.9%, 80% to 97%, 80% to 95%, or 80% to 90% of the V_{V}. In some embodiments, the solid-state electrolyte occupies 90% to 99.9%, 90% to 97%, or 90% to 95% of the V_{V}. In some embodiments, the solid-state electrolyte occupies 95% to 99.9% or 95% to 97% of the V_{V}. In some embodiments, the solid-state electrolyte occupies 97% to 99.9% of the V_{V}. In some embodiments, the solid-state electrolyte occupies 90% or greater of the V_{V}.

In some embodiments, the methods used to deposit the solid-state electrolyte within the electrode assembly 40 in may increase the likelihood of the solid-state electrolyte being confined to the V_{V}. Such methods include, but are not limited to, in situ polymerization and/or melt infiltration of the solid-state electrolyte into the V_{V}. In situ polymerization refers to polymerizing an electrolyte precursor mixture within the electrode assembly 40 to form the solid-state electrolyte (described in detail below). In some embodiments, in situ polymerization may be used to deposit a gel polymer electrolyte within the electrode assembly 40. In some embodiments, the solid-state electrolyte includes or is an in situ polymerized gel. Melt infiltration refers to depositing a liquid electrolyte precursor into the electrode assembly 40 followed by freezing the liquid electrolyte precursor to from the solid-state electrolyte. In some embodiments, melt infiltration is used to deposit an inorganic electrolyte or a plastic crystal electrolyte in the electrode assembly 40. In some embodiments, the solid-state electrolyte includes or is a melt-infiltrated inorganic electrolyte. In some embodiments, the solid-state electrolyte includes or is a melt-infiltrated plastic crystal electrolyte. In both methods, the volume of the solid-state electrolyte is adjusted so as not to exceed the V_{V}.

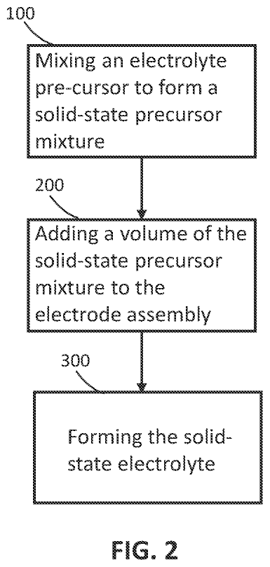

FIG. 2 illustrates the general steps used in some embodiments to deposit the solid-state 70 electrolyte into the electrode assembly 40. Generally, depositing the solid-state electrolyte into the electrode assembly includes mixing an electrolyte pre-cursor to form a solid-state precursor mixture 100. The method further includes adding a volume of the solid-state precursor mixture to the electrode assembly 200. The method further includes forming the solid-state electrolyte 300.

The electrolyte precursor includes any compound or compounds useful for forming a solid-state electrolyte such as those solid-state electrolytes discussed elsewhere (e.g., a gel polymer electrolyte, polymer electrolyte, a plastic crystal electrolyte, or an inorganic electrolyte). For example, in some embodiments, the electrolyte precursor includes one or more lithium salt species and one or more monomer species suitable for forming a gel polymer electrolyte. In some embodiments, the gel polymer solid-state electrolyte includes or is an in situ polymerized gel electrolyte. In some embodiments, the electrolyte precursor may include one or more initiator species suitable for initiating the polymerization of one or more monomer species to form a solid-state electrolyte (e.g., gel polymer electrolyte). In some embodiments, the electrolyte may include one or more solvents suitable for the formation of a solid-state electrolyte. In some embodiments, the electrolyte precursor may include one or more lithium salt species and one or more compound species suitable for forming a plastic crystal electrolyte. In some embodiments, the electrolyte precursor may include one or more lithium salts suitable for forming an inorganic electrolyte. In some embodiments, the solid-state electrolyte 70 includes or is a melt-infiltrated inorganic electrolyte. In some embodiments, the solid-state electrolyte 70 includes or is a melt-infiltrated plastic crystal electrolyte.

In some embodiments, mixing an electrolyte pre-cursor to form a solid-state precursor mixture 100 is done at temperature above the melting temperature of the electrolyte pre-cursor components, for example, when employing the melt infiltration deposition technique.

In some embodiments, adding a volume of the solid-state precursor mixture to the electrode assembly 200 includes adding a volume equal to or less than the V_{V}. The V_{V} may be calculated as described above in equation 2. In some embodiments, adding a volume of the solid-state precursor mixture to the electrode assembly 200 is done at a temperature above the melting temperature of the electrolyte pre-cursor components, for example, when employing the melt infiltration deposition technique.

In some embodiments, forming the solid-state electrolyte 300 includes polymerizing the solid-state precursor mixture, for example, when employing the in-situ polymerization deposition technique. In some embodiments, the solid-state precursor mixture is exposed to a thermal treatment thereby forming the solid-state electrolyte. In some embodiments, the solid-state precursor mixture is exposed to a thermal treatment thereby forming the gel polymer electrolyte. In some embodiments, the solid-state precursor mixture is exposed to an ultraviolet treatment thereby forming the solid-state electrolyte. In some embodiments, the solid-state precursor mixture is exposed to an ultraviolet treatment thereby forming the gel polymer electrolyte.

In some embodiments, forming the solid-state electrolyte 300 includes freezing the solid-state precursor mixture, for example, when employing the melt infiltration deposition technique. This method includes cooling the solid-state precursor mixture to a temperature that is below the freezing point of the components of the solid-state precursor mixture to form the solid-state electrolyte 300. In some embodiments, this method includes cooling the solid-state precursor mixture to a temperature that is below the freezing point of the components of the solid-state precursor mixture to form an inorganic electrolyte. In some embodiments, this method includes cooling the solid-state precursor mixture to a temperature that is below the freezing point of the components of the solid-state precursor mixture to form a plastic crystal electrolyte.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

### EXAMPLES

Methods of preparing exemplary batteries are illustrated by the following examples. It is to be understood that the particular examples, materials, amounts, and procedures are to be interpreted broadly in accordance with the scope and spirit of the present disclosure.

### Example 1

### Conductive Housing Insulative Coatings

Electrically insulating, non-porous coatings that do not intercalate or react with lithium ions can be achieved through various physical vapor deposition (PVD), chemical vapor deposition (CVD) or atomic layer deposition (ALD) methods. For example, Al₂O₃ coatings may be deposited by RF sputtering, cathodic arc deposition, electron beam evaporation. Referring to FIG. 1A, the regions 29 and 38 inside the battery may be exposed to the coating during the thin film deposition process by masking the rest of the inside surface of the battery (22) either through physical, shadow masks or photoresist based lithographical masks. Coating thicknesses may range between 200 nanometers and 5 micrometers with the intent to achieve a dense, non-porous film that shields the underlying surface from contact with the battery electrolyte. In certain cases, multi-layer films may be deposited with varying porosities to achieve robust films with good adhesion to the underlying substrate (inner surface of the battery, 22) and mechanical integrity to withstand the use conditions of the films inside the battery, e.g., high temperature and low temperature exposures that may cause stresses to build inside the films that can potentially lead to delamination or cracking. The multi-layer films may also include adhesion promoting layers immediately adjacent to the inner surface of the battery, 22, different in chemical composition from the top layer film exposed to the battery electrolyte.

### Thermally Crosslinked Gel Polymer Electrolyte

Liquid electrolyte containing 20 mol % LiTFSI dissolved in tetraglyme was mixed with polyethylene glycol diacrylate (PEGDA 750 Da) such that the resulting solution contained 10 wt. % PEGDA in the combined electrolyte. Thermal initiator, benzoyl peroxide (Luperox A98), measuring 1% of the total weight of PEGDA was introduced into the combined electrolyte to create the pre-gelled electrolyte precursor. Crosslinked, gelled electrolyte was achieved by exposing the pre-gelled electrolyte precursor to 75° C. for approximately 100 minutes.

When it is desirable to achieve crosslinked gel electrolyte inside the battery, the pre-gelled electrolyte precursor is filled into the battery to fill the pores of the electrode and separator assembly first. Subsequently, the battery containing the electrode assembly and the pre-gelled electrolyte precursor is exposed to elevated temperature, such as 75° C. for up to 100 minutes to gel the electrolyte in place, in the pores of the electrode, separator assembly.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

What is claimed is:

1. A battery comprising:
a conductive housing comprising an inner surface, an outer surface, a proximal end, and a distal end;
a header assembly disposed at the proximal end, the header assembly comprising a header cap, the header cap having an inner surface;
an electrode assembly disposed within the conductive housing proximate to the inner surface and between the proximal end and the distal end of the conductive housing, the electrode assembly comprising:
at least two electrodes comprising an anode and a cathode;
an interelectrode region defining an interelectrode volume; and
an electrolyte; and
one or more features comprising:
an electrically insulative coating coats at least a portion of the inner surface of the conductive housing; and
the electrolyte comprises a solid-state electrolyte.

2. The battery of claim 1, wherein the electrolyte is a liquid electrolyte.

3. The battery of claim 1, wherein the electrolyte is a solid-state electrolyte.

4. The battery of claim 3, wherein the cathode comprises pores, the pores and the interelectrode volume defining a void volume, the solid-state electrolyte being confined to the void volume.

5. The battery of claim 4, wherein the interelectrode region comprises a porous separator.

6. The battery of claim 3, wherein the solid-state electrolyte comprises:
a gel polymer electrolyte comprising a lithium containing salt and a polymer capable of forming a gel with the lithium salt;
a plastic crystal electrolyte comprising a lithium containing salt and a nonionic plastic crystal, an ionic plastic crystal, or a combination thereof;
an inorganic electrolyte comprising a perovskite type electrolyte, a sodium superionic conductor type electrolyte, a lithium super ionic conductor type electrolyte, a garnet type electrolyte, a thia-lithium super ionic conductor type electrolyte, a sulfide glass, an anti-perovskite type electrolyte, or a combination thereof; or
a combination thereof.

7. The battery of claim 1 further comprising an electrically insulative coating on at least a portion of the inner surface of the header assembly, wherein the electrically insulative coating comprises a polymer, an inorganic compound, or a combination thereof.

8. The battery of claim 7, wherein at least one electrode is coupled to the inner surface of the conductive housing, and wherein the electrically insulative coating is not on the inner surface portion of the conductive housing to which the at least one electrode is coupled.

9. A battery comprising:
a conductive housing having an inner surface, a proximal end, and a distal end;
a header assembly coupled to the proximal end; and
an electrode assembly disposed within the housing proximate to the inner surface and between the proximal end and the distal end of the conductive housing, the electrode assembly comprising:
at least two electrodes comprising an anode and a cathode, the cathode comprising pores;
an interelectrode region, the pores and the interelectrode region defining a void volume; and
a solid-state electrolyte prepared by:
mixing an electrolyte pre-cursor to form a solid-state precursor mixture;
adding a volume of the solid-state precursor mixture to the electrode assembly, the volume being the same or less than the void volume; and
forming the solid-state electrolyte, the solid-state electrolyte being confined to the void volume.

10. The battery of claim 9, wherein forming the solid-state electrolyte comprises polymerizing the solid-state precursor mixture via a thermal or an ultraviolet treatment.

11. The battery of claim 9, wherein the solid-state electrolyte comprises:
a gel polymer electrolyte comprising a lithium containing salt and a polymer capable of forming a gel with the lithium salt;
a plastic crystal electrolyte comprising a lithium containing salt and a nonionic plastic crystal, an ionic plastic crystal, or a combination thereof;
an inorganic electrolyte comprising a perovskite type electrolyte, a sodium superionic conductor type electrolyte, a lithium super ionic conductor type electrolyte, a garnet type electrolyte, a thia-lithium super ionic conductor type electrolyte, a sulfide glass, an anti-perovskite type electrolyte, or a combination thereof; or
a combination thereof.

12. The battery of claim 9, wherein mixing the electrolyte pre-cursor and adding a volume of the mixture to the electrode assembly are done above a melting temperature of the electrolyte pre-cursor, and forming the solid-state electrolyte comprises cooling the electrode assembly to freeze the mixture into the solid-state electrolyte.

13. The battery of claim 9, wherein the interelectrode region comprises a porous separator.

14. A method of making a battery, the method comprising:
constructing a conductive housing having an inner surface, a proximal end and a distal end;
coupling a header assembly to the proximal end;
preparing an electrode assembly comprising at least two electrodes comprising an anode and a cathode, an interelectrode region, and a solid-state electrolyte; and
disposing the electrode assembly within the conductive housing proximate the inner surface and between the proximal end and the distal end of the conductive housing.

15. The method of claim 14, wherein the cathode comprises pores, the pores and the interelectrode region defining a void volume, and the solid-state electrolyte confined to the void volume.

16. The method of claim 14, wherein interelectrode region comprises a porous separator.

17. The method of claim 15, wherein the solid-state electrolyte is prepared by:
mixing an electrolyte pre-cursor to form a solid-state precursor mixture;
adding a volume of the solid-state precursor mixture to the electrode assembly, the volume being the same or less than the void volume; and
forming the solid-state electrolyte, the solid-state electrolyte being confined to the void volume.

18. The method of claim 14, wherein the solid-state electrolyte comprises:
a gel polymer electrolyte comprising a lithium containing salt and a polymer capable of forming a gel with the lithium salt;
a plastic crystal electrolyte comprising a lithium containing salt and a nonionic plastic crystal, an ionic plastic crystal, or a combination thereof;
an inorganic electrolyte comprising a perovskite type electrolyte, a sodium superionic conductor type electrolyte, a lithium super ionic conductor type electrolyte, a garnet type electrolyte, a thia-lithium super ionic conductor type electrolyte, a sulfide glass, an anti-perovskite type electrolyte, or a combination thereof; or
a combination thereof.

19. The method of claim 14, further comprising applying an electrically insulative coating on at least a portion of the inside surface of the conductive housing, at least a portion of the header assembly proximate to the inner surface of the conductive housing, or both.

20. The method of claim 14, wherein the battery is a lithium metal battery or a lithium-ion battery.
